(19) United States
(12) Patent Application Publication
(10) Pub. No.: US 2023/0187959 A1
(43) Pub. Date: Jun. 15, 2023

(54) PORTABLE DEVICE BATTERY CHARGER

(71) Applicant: TEXAS INSTRUMENTS INCORPORATED, Dallas, TX (US)

(72) Inventors: Jing YE, Dallas, TX (US); Gautham RAMACHANDRAN, Allen, TX (US); Chandradevi ULAGANATHAN, McKinney, TX (US); Sai Bun WONG, Coppell, TX (US)

(21) Appl. No.: 17/732,678

(22) Filed: Apr. 29, 2022

Related U.S. Application Data
(60) Provisional application No. 63/289,663, filed on Dec. 15, 2021.

(51) Int. Cl. H02J 7/00; H02J 7/34

(52) U.S. Cl. CPC H02J 7/007182; H02J 7/342; H02J 7/00304; H02J 7/00308; H02J 7/00309; H02J 7/0045; H02J 7/0047; H02J 2207/20

(57) ABSTRACT

A battery charger circuit includes a linear charging control circuit. The linear charging control circuit is coupled between an input terminal and a battery terminal. The linear charging control circuit is configured to apply a charging voltage from the input terminal to the battery terminal, and in a fast charging phase, cause the charging voltage to track a battery voltage while drawing a constant charging current.

### CROSS-REFERENCE TO RELATED APPLICATIONS

This application claims priority to U.S. Provisional Application No. 63/289,663, filed Dec. 15, 2021, entitled “Fast Charging Solution for Portable Device from Battery Power,” which is hereby incorporated by reference.

### BACKGROUND

Portable electronic devices are generally powered by a battery. As the size of portable devices shrinks, the space available to house a battery also shrinks. To improve the usability of portable devices with relatively small batteries, portable devices with limited internal power storage may be paired with a portable charging case. The portable charging case includes a larger battery than the portable device. The portable device is installed in the portable charging case to charge the battery of the portable device. The larger battery within the portable charging case may be charged from the power mains via a wired or wireless power connection.

### SUMMARY

In one example, a portable system includes a portable charger and a portable device. The portable charger includes a first charging terminal, a first battery, and a buck-boost converter. The buck-boost converter is coupled to the first battery and the first charging voltage terminal. The buck-boost converter is configured to provide a charging voltage at the first charging terminal, the charging voltage limited to a predetermined voltage at a predetermined current. The portable device is coupled to the portable charger. The portable device includes a second charging terminal, a second battery, and a linear charging circuit. The second charging terminal is coupled to the first charging terminal. The linear charging circuit is configured to apply the charging voltage to charge the second battery. The linear charging circuit is also configured to, in a charging phase, cause the charging voltage to track a voltage of the second battery while drawing a constant current from the buck-boost converter.

In another example, a method includes providing a charging voltage to a portable device, the charging voltage limited to a predetermined voltage at a predetermined current. The method also includes, in the portable device, applying the charging voltage to charge a battery of the portable device in a charging phase, and, in the charging phase, causing the charging voltage to track a voltage of the second battery while providing a constant current to the battery.

In a further example, a battery charger circuit includes a linear charging control circuit. The linear charging control circuit is coupled between an input terminal and a battery terminal. The linear charging control circuit is configured to apply a charging voltage from the input terminal to the battery terminal, and in a fast charging phase, cause the charging voltage to track a battery voltage while drawing a constant charging current.

### BRIEF DESCRIPTION OF THE DRAWINGS

FIG. 1 is a block diagram of an example portable system that includes battery charging as described herein.

FIG. 2 is a block diagram for an example linear charging circuit that provides battery charging as described herein.

FIG. 3 is a graph showing example charging phases in the linear charging circuit of FIG. 2.

FIG. 4 is a flow diagram for an example method for battery charging as described herein.

### DETAILED DESCRIPTION

Portable systems, such as True Wireless Stereo (TWS) earbuds, include a portable device (the earbuds), and a battery powered charging case that can house the earbuds when not in use or for recharging prior to use. An earbud includes a small capacity battery and a linear charging circuit. The linear charging circuit is used because the earbud lacks sufficient space for the inductor of a switch-mode charging circuit. The charging case includes a larger battery and a switch-mode charging circuit for charging the earbud battery when the earbud is installed in the case. Three metrics may be applied to evaluate battery management in such portable systems: 1) case and device temperature; 2) charging time; and 3) number of portable device charging cycles provided by the charging case (without recharging the case battery).

When the charging case is coupled to an external power source (e.g., a charger coupled to the power mains), the switch-mode charging circuit (e.g., operating in buck mode) applies power received from the external power source to charge the case's battery, and the charging case provides power received from the external power source to charge the portable device's battery. When the external power source is not coupled to the charging case, the switch-mode charging circuit (e.g., operating in boost mode) draws power from the case's battery to generate a higher voltage (e.g., 5 volts) that is provided to the linear charging circuit of the portable device for charging the portable device's battery. Such a charging system is subject to a variety of problems. The boosted output of the charging case (e.g., 5 volts) may be substantially higher than the voltage of the portable device battery (e.g., 3.3-3-8 volts), resulting in low efficiency with the linear charging circuit of the portable device (e.g., 66%-70% efficiency). Low conversion efficiency produces significant heat within the portable device, which increases the temperature of the portable device. For example, a temperature increase of about 20° Celsius is possible with a high charging current. Because the portable device may be placed in close proximity to the user (e.g., the user's ear) during operation, the portable device should be maintained at a relatively low temperature. Temperature also limits the charging rate of the portable device, i.e., charging current may be reduced to limit temperature increase, which increases charging time. Low conversion efficiency also reduces the number of charging cycles the charging case can provide to the portable device. Use of a larger battery in the charging case, to compensate for low conversion efficiency, increases cost and size.

The portable system disclosed herein includes battery management that improves charging efficiency (95% efficiency or higher), which results in smaller temperature increase during charging, and increases the number of charging cycles provided by the charging case. Power dissipation is greatly reduced (e.g., reduced by over 80%), which enables faster charging. For example, the portable device's battery may be charged at a 6 C rate rather than a 1 C or 2 C rate. The charging case includes a constant-current, constant-voltage based buck-boost converter that can regulate the charging voltage provided to the portable device to be higher than the voltage of the portable device's battery voltage by a predetermined amount, and can limit the charging current to a predetermined value. For example, the charging voltage provided to the portable device may be only a few hundred millivolts higher than the voltage of the portable device's battery. The linear charging circuit of the portable device fully turns on all transistors passing current from the charging case to the portable device's battery to reduce voltage drop (increase efficiency), while continuing to operate various protection circuits (e.g., overvoltage, overcurrent, etc.). The linear charging circuit may charge the battery using a charging voltage as low as 3.2 volts (V) (≤3.2 V in some implementations) and charging current of up to one ampere (A) (≥1 A in some implementations). If the portable device detects a fault condition during charging, the transistors may be automatically turned off (or channel resistance increased) until the fault is corrected. No communication between the charging case and the portable device is needed to control charging.

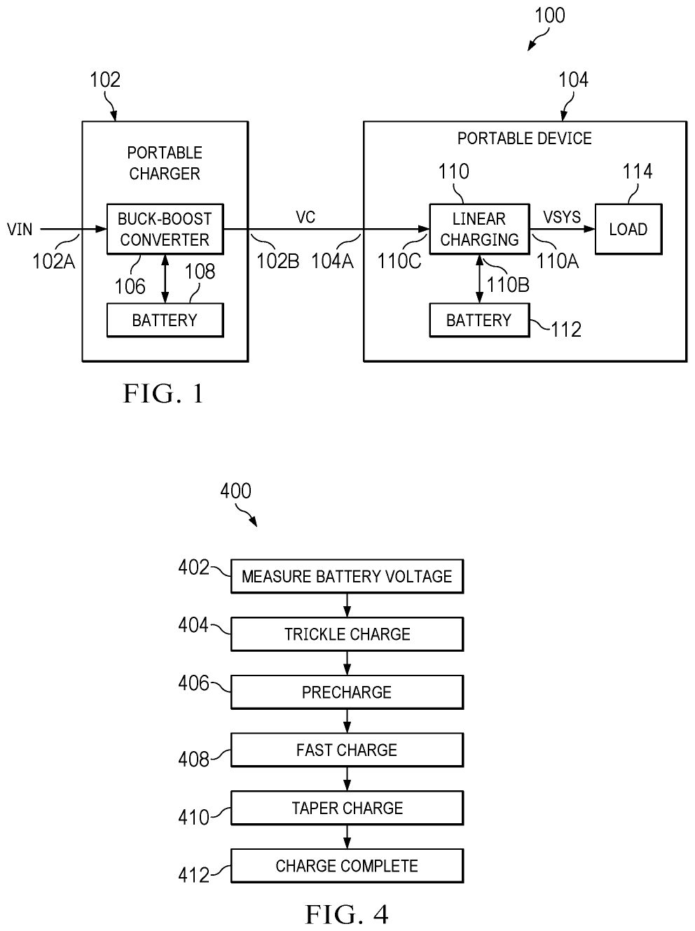

FIG. 1 is a block diagram of an example portable system 100 that includes battery charging as described herein. The portable system 100 includes a portable charger 102 and a portable device 104. The portable charger 102 may be a charging case or housing configured to hold the portable device 104 and to charge the portable device 104 while the portable device 104 is coupled to the portable charger 102. For example, the portable charger 102 may charge the portable device 104 while the portable device 104 is being transported within the portable charger 102. The portable device 104 may be, for example, a TWS earbud or another battery-powered portable appliance.

The portable charger 102 includes a buck-boost converter 106 and a battery 108. The portable charger 102 includes an input terminal 102A for receiving a voltage (VIN) from an external power source (e.g., an external power supply powered by the power mains). The portable charger 102 applies the voltage received at the input terminal 102A to charge the battery 108. The battery 108 may be a lithium-ion battery, a lithium iron phosphate battery, or other type of battery. The battery 108 may have nominal voltage in a range of 3.3 volts to 4.5 volts in some implementations. VIN may be about 5 volts in some implementations of the portable system 100, and the buck-boost converter 106 operates as buck converter to step down VIN for use in charging the battery 108. The buck-boost converter 106 regulates the charging voltage (VC) and the charging current provided to the portable device 104. For example, the buck-boost converter 106 may regulate VC to a voltage that is a predetermined voltage higher (e.g., a few tenths, two tenths, etc. of a volt higher) than the highest desired voltage of the battery 112 of the portable device 104. The buck-boost converter 106 may limit the charging current to a maximum current desired for fast charging the battery 112. When the portable charger 102 is charging the portable device 104, if the voltage of the battery 108 is greater than a voltage (VC) selected for charging the portable device 104, then the buck-boost converter 106 operates as a buck converter to step-down the voltage of the battery 108 to VC. If the voltage of the battery 108 is less than VC, then the buck-boost converter 106 operates as a boost converter to step-up the voltage of the battery 108 to VC. The portable charger 102 includes a charging terminal 102B that is coupled to a charging terminal 104A of the portable device 104 for transfer of VC from the portable charger 102 to the portable device 104. The charging terminal 102B and the charging terminal 104A may be terminals of connectors (two-terminal connectors) of the portable charger 102 and the portable device 104.

The portable device 104 includes a linear charging circuit 110, a battery 112, and a load circuit 114. The load circuit 114 may include wireless communication circuitry, audio circuitry, or other circuitry for providing the functionality of the portable device 104. The battery 112 may be a lithium-ion battery, a lithium iron phosphate battery, or other type of battery. The linear charging circuit 110 controls charging of the battery 112, and powering of the load circuit 114 from the battery 112 or from VC. For example, when the portable device 104 is coupled to the portable charger 102, the linear charging circuit 110 may switch VC to power the load circuit 114. When the portable device 104 is not coupled the portable charger 102, the linear charging circuit 110 may switch power from the battery 112 to the load circuit 114. The linear charging circuit 110 includes a load terminal 110A coupled to the load circuit 114, a battery terminal 1108 coupled to the battery 112, and a charging terminal 110C coupled to the charging terminal 104A of the portable device 104. The linear charging circuit 110 provides for fast and efficient charging of the battery 112 without inclusion a switching DC-DC converter and the attendant cost and circuit area (e.g., a DC-DC converter typically requires more logic and transistors for implementation than the linear charging circuit 110). Thus, the linear charging circuit 110 allows for reduction in size of the portable device 104 and reduction in temperature of the portable device 104 during charging.

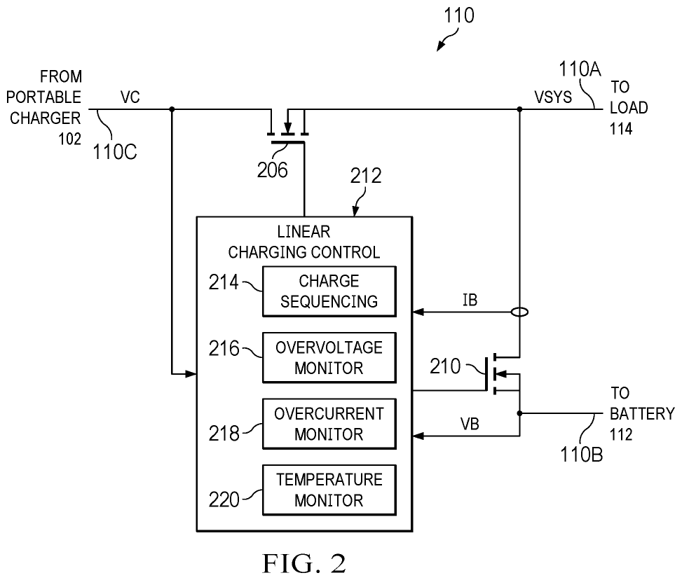

FIG. 2 is a block diagram for an example linear charging circuit 110. The linear charging circuit 110 includes a linear charging control circuit 212, a transistor 206, and a transistor 210. The transistor 206 controls the flow of charging current to the load terminal 110A. The transistor 210 controls the flow of charging current to the battery terminal 1106, and the flow of current from the battery 112 to the load terminal 110A. Voltage provided at the load terminal 110A is denoted VSYS. The linear charging control circuit 212 controls the transistor 206 and the transistor 210 for charging and discharging the battery 112.

The transistor 206 may be an N-type field effect transistor in some implementations of the linear charging circuit 110. The transistor 206 may include a drain coupled to the charging terminal 110C, a source coupled to the load terminal 110A, and a gate coupled to an output of the linear charging control circuit 212. The linear charging control circuit 212 provides a control voltage at the gate of the transistor 206 to control the flow of current from the charging terminal 110C to the load terminal 110A for powering the load circuit 114, or to the transistor 210 for charging the battery 112.

The transistor 210 may be an N-type field effect transistor in some implementations of the linear charging circuit 110. The transistor 210 may include a drain coupled to the load terminal 110A, a source coupled to the battery terminal 1106, and a gate coupled to an output of the linear charging control circuit 212. The linear charging control circuit 212 provides a control voltage at the gate of the transistor 210 to control the flow of current from the transistor 210 to the battery 112 for charging, and the flow of current from the load circuit 114 to the load terminal 110A for powering the load circuit 114.

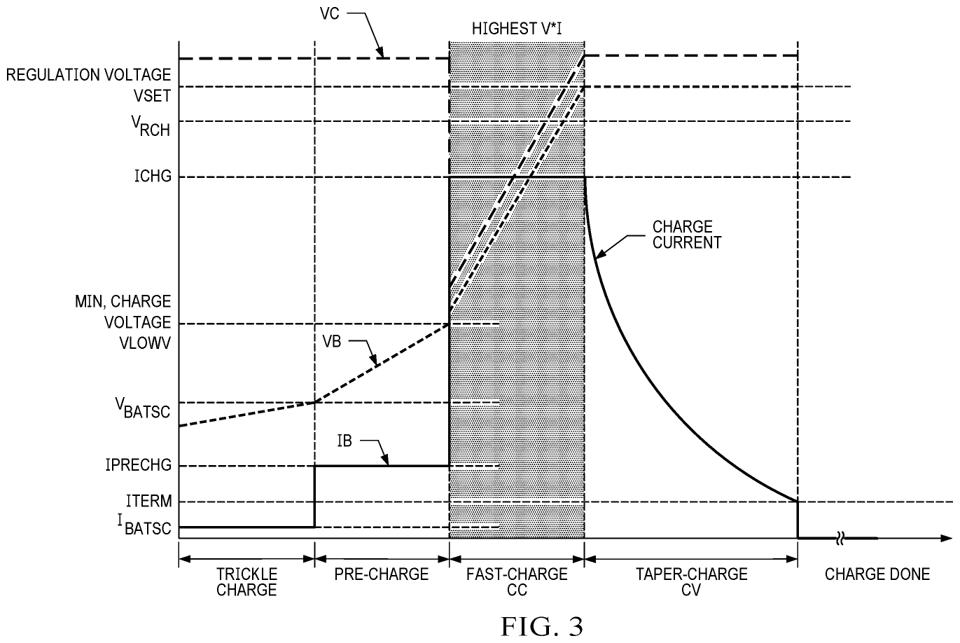

The linear charging control circuit 212 monitors the charging voltage (VC) received from the portable charger 102, the voltage (VB) of the battery 112, and the current (IB) flowing to/from the battery 112 to control the transistor 206, the transistor 210, and charging of the battery 112. The linear charging control circuit 212 includes an input coupled to the charging terminal 110C for receipt of VC, an input coupled to the battery terminal 110B for receipt of VB, and an input coupled to the drain of the transistor 210 for monitoring the current flowing to or from the battery 112. The linear charging control circuit 212 includes a charge sequencing circuit 214, an overvoltage monitor circuit 216, and an overcurrent monitor circuit 218. The charge sequencing circuit 214 controls the charging of the battery 112 based on VC, VB, VSYS, and IB. The charge sequencing circuit 214 may include control circuitry, such as state machine circuitry to manage charging of the battery 112, driver circuitry to drive the transistor 206 and the transistor 210, and comparators to compare the VC, the VB, and the IB to various thresholds (e.g., thresholds corresponding to charging state transitions), and reference circuitry to generate the thresholds. Further explanation of the operation of the charge sequencing circuit 214 to select charging phases is provided with reference to FIG. 3.

The overvoltage monitor circuit 216 monitors VC to detect an overvoltage fault condition. For example, the overvoltage monitor circuit 216 may include a comparator that compares VC to an overvoltage threshold to determine whether VC exceeds a predetermined maximum voltage for charging the battery 112 or powering the load circuit 114. If VC exceeds the overvoltage threshold, the transistor 206 may be turned off to block VC from the load circuit 114 and the battery 112.

The overcurrent monitor circuit 218 monitors IB to detect an overcurrent fault condition. For example, the overcurrent monitor circuit 218 may include a comparator that compares IB to an overcurrent threshold to determine whether IB exceeds a predetermined maximum current for powering the load circuit 114. If IB exceeds the overcurrent threshold, the transistor 206 may be turned off to block the flow of current from the battery 112 to the load circuit 114.

The linear charging control circuit 212 may also include a temperature monitor circuit 220 that measures the temperature of the linear charging circuit 110 (e.g., measures the junction temperature of a die on which the linear charging circuit 110 is fabricated). The temperature monitor circuit 220 may also monitor the temperature of the battery 112 via an external temperature sensor (e.g., a thermistor). The temperature monitor circuit 220 may include circuitry that compares the measured temperature (e.g., a voltage representing temperature) to one or more temperature thresholds to detect an overtemperature fault. For example, if, while charging the battery 112, the temperature of the linear charging circuit 110 or the battery 112 exceeds a charging temperature threshold, the linear charging control circuit 212 may reduce the charging current to prevent overheating of the linear charging circuit 110 or the battery 112. If the temperature of the linear charging circuit 110 exceeds a shutdown temperature threshold, the linear charging control circuit 212 may discontinue charging of the battery 112, and discontinue provision of VSYS at the load terminal 110A.

Some implementations of the 216, 218, and 220 may include an analog-to-digital converter that digitizes voltage, current, and temperature measurements, and digital comparator circuitry that compares the digital values to overcurrent, overvoltage, and overtemperature threshold values to detect overcurrent, overvoltage, and overtemperature faults.

FIG. 3 is a graph showing an example of charging controlled by the linear charging circuit 110. The linear charging circuit 110 autonomously charges the battery 112 using four charging phases selected by the charge sequencing circuit 214. The linear charging circuit 110 selects (activates) the appropriate charging phase based on VB. If VB is less than a short circuit threshold voltage (V_{BATSC}) (e.g., ≈1.8 volts), then the linear charging circuit 110 charges the battery 112 in a trickle charge phase until VB exceeds V_{BATSC}. In the trickle charge phase, the charging current (IB) is set to a relatively low constant current value (IBATSC) (e.g., ≈8 milliamperes), and VC is set to the maximum regulated charging voltage (e.g., ≈5 volts) provided by the portable charger 102.

When VB exceeds V_{BATSC}, but is lower than a minimum voltage specified for fast charging (VLOWV) (e.g., ≈2.7-3 volts), the linear charging circuit 110 charges the battery 112 in a pre-charge phase. For example, when charging in the trickle charge phase increases VB to a voltage greater than V_{BATSC}, the linear charging circuit 110 autonomously transitions from trickle charge phase to pre-charge phase. In pre-charge phase, VC is set to the maximum regulated charging voltage provided by the portable charger 102, and IB is set to a constant pre-charge current (IPRECHG) that may be greater than IBATSC. For example, IPRECHG may be about 20% of the constant current ICHG used in fast-charge phase.

When VB exceeds VLOWV, but is lower than a predetermined target voltage (VSET), the linear charging circuit 110 charges the battery 112 in a fast-charge phase. For example, when charging in the pre-charge phase increases VB to a voltage greater than VLOWV, the linear charging circuit 110 autonomously transitions from pre-charge phase to fast-charge phase. In the fast-charge phase, the linear charging circuit 110 fully turns on the transistor 206 and transistor 210 to reduce voltage drop. The IB is set to a constant charge current (ICHG). ICHG may be the maximum charge current applied to the charge the battery 112. ICHG may be regulated by the portable charger 102, such that VC increases to maintain a desired offset from VB during charging. In the fast-charge phase, VC tracks VB (as VB increases with charging) to increase charging efficiency. For example, VC may be a few hundred (e.g., 200) millivolts greater than VB throughout the fast-charge phase.

When VB approaches (e.g., is equal to) a target voltage (VSET) (e.g., selectable in a range of 3.5-4.65 volts), the linear charging circuit 110 charges the battery 112 in a taper-charge phase. For example, when charging in the fast-charge phase increases VB to about VSET, the linear charging circuit 110 autonomously transitions from fast-charge phase to taper-charge phase. In taper-charge phase, VC is set to the maximum regulated charging voltage provided by the portable charger 102, and IB is gradually reduced until equal to a termination current (ITERM) (e.g., of ICHG). Charging is complete when IB equals ITERM in the taper-charge phase.

Responsive to detection of an overcurrent fault or an overvoltage fault, the linear charging circuit may exit any currently selected charging phase and deactivate the transistors 206 and 210.

FIG. 4 is a flow diagram for an example method 400 for charging the battery 112 of the portable device 104. Though depicted sequentially as a matter of convenience, at least some of the actions shown can be performed in a different order and/or performed in parallel. Additionally, some implementations may perform only some of the actions shown.

In block 402, the linear charging control circuit 212 measures VB. The linear charging control circuit 212 selects a charging phase for charging the battery 112 based on the measured VB.

In block 404, the linear charging control circuit 212 sets the linear charging circuit 110 to charge the battery 112 in trickle charge phase. The linear charging control circuit 212 selects trickle charge phase operation if VB is less than V_{BATSC}. The portable device 104 charges the battery 112 in trickle charge phase until VB exceeds V_{BATSC}. In the trickle charge phase, the charging current (IB) is set to relatively low constant current value (IBATSC), and VC is set to the maximum regulated charging voltage provided by the portable charger 102.

In block 406, the linear charging control circuit 212 sets the linear charging circuit 110 to charge the battery 112 in pre-charge phase. The linear charging control circuit 212 selects pre-charge phase operation if VB exceeds V_{BATSC}, but is lower than a minimum voltage specified for fast charging (VLOWV). For example, when charging in the trickle charge phase increases VB to a voltage greater than V_{BATSC}, the linear charging circuit 110 autonomously transitions from trickle charge phase to pre-charge phase. In pre-charge phase, VC is set to the maximum regulated charging voltage provided by the portable charger 102, and IB is set to a pre-charge current (IPRECHG) that may be greater than IBATSC.

In block 408, the linear charging control circuit 212 sets the linear charging circuit 110 to charge the battery 112 in fast-charge phase. The linear charging control circuit 212 selects fast-charge phase operation if VB exceeds VLOWV, but is lower than a predetermined target voltage (VSET). For example, when charging in the pre-charge phase increases VB to a voltage greater than VLOWV, the linear charging circuit 110 autonomously transitions from pre-charge phase to fast-charge phase. In the fast-charge phase, the portable device 104 fully turns on the transistor 206 and transistor 210 to reduce voltage drop. The IB is set to a constant charge current (ICHG). ICHG may be the maximum charge current applied to the charge the battery 112. ICHG may be regulated by the portable charger 102. In the fast-charge phase, VC tracks VB to increase charging efficiency. For example, VC may be a few hundred (e.g., 200) millivolts greater than VB throughout the fast-charge phase.

In block 410, the linear charging control circuit 212 sets the linear charging circuit 110 to charge the battery 112 in taper-charge phase. The linear charging control circuit 212 selects taper-charge phase if VB approaches (e.g., is approximately equal to) a target voltage (VSET). For example, when charging in the fast-charge phase increases VB to about VSET, the portable device 104 autonomously transitions from fast-charge phase to taper-charge phase. In taper-charge phase, VC is set to the maximum regulated charging voltage provided by the portable charger 102, and IB is gradually reduced until equal to termination current (ITERM). Charging is complete when IB equals ITERM in the taper-charge phase.

In block 412, charging of the battery 112 is complete. The linear charging control circuit 212 monitors VB in block 402 to determine whether additional charging is needed. If additional charging is needed, then the linear charging control circuit 212 initiates the appropriate charging phase in blocks 404-410.

The linear charging control circuit 212 performs the charging phase transitions of the method 400 independent of control from a host device. Through charging, and the various charging phase transitions of the method 400, overvoltage, overcurrent, and temperature monitoring protect the load circuit 114 from transient events (e.g., current transients, voltage transients, temperature transients).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

While the use of particular transistors is described herein, other transistors (or equivalent devices) may be used instead. For example, a p-channel field effect transistor (“PFET”) may be used in place of an n-channel field effect transistor (“NFET”) with little or no changes to the circuit. Furthermore, other types of transistors may be used (such as bipolar junction transistors (BJTs)).

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as transistors, unless otherwise stated, are generally representative of any one or more transistors coupled in parallel to provide desired channel width or emitter size.

In this description, unless otherwise stated, “about,” “approximately,” or “substantially” preceding a parameter means being within +/−10 percent of that parameter.

Modifications are possible in the described embodiments, and other embodiments are possible, within the scope of the claims.

What is claimed is:

1. A portable system, comprising:
a portable charger, including:
a first charging terminal;
a first battery; and
a buck-boost converter coupled to the first battery and the first charging terminal, and configured to provide a charging voltage at the first charging terminal, the charging voltage limited to a predetermined voltage at a predetermined current.
a portable device coupled to the portable charger, and including:
a second charging terminal coupled to the first charging terminal;
a second battery; and
a linear charging circuit configured to:
apply the charging voltage to charge the second battery; and
in a charging phase, cause the charging voltage to track a voltage of the second battery while drawing a constant current from the buck-boost converter.

2. The portable system of claim 1, wherein the linear charging circuit is configured to, in the charging phase, maintain an offset of no more than about 200 millivolts between the voltage of the second battery and the charging voltage.

3. The portable system of claim 1, wherein:
the linear charging circuit includes:
a load terminal;
a battery terminal coupled to the second battery;
a first transistor coupled between the load terminal and the second charging terminal; and
a second transistor coupled between the load terminal and the battery terminal; and
the linear charging circuit is configured to, in the charging phase, fully turn on the first transistor and the second transistor.

4. The portable system of claim 1, wherein:
the charging phase is a first charging phase;
the linear charging circuit is configured to transition from the first charging phase to a second charging phase responsive to the voltage of the second battery exceeding a first threshold; and
the charging voltage is constant in the second charging phase.

5. The portable system of claim 1, wherein:
the linear charging circuit includes:
a temperature monitor circuit;
an overvoltage monitor circuit; and
an overcurrent monitor circuit, and
the linear charging circuit is configured to exit the charging phase responsive to detection of an overtemperature fault, an overvoltage fault, or an overcurrent fault.

6. The portable system of claim 1, wherein:
the charging phase is a first charging phase;
the linear charging circuit is configured to:
activate the first charging phase responsive to the voltage of the second battery exceeding a threshold while charging the second battery in a second charging phase; and
in the second charging phase, the charging voltage is constant and the charging current is constant.

7. The portable system of claim 6, wherein the charging current applied in the second charging phase is lower than the charging current applied in the first charging phase.

8. The portable system of claim 6, wherein:
the threshold is a first threshold;
the linear charging circuit is configured to:
activate the second charging phase responsive to the voltage of the second battery exceeding a second threshold while charging the second battery in a third charging phase;
in the third charging phase, the charging voltage is constant and the charging current is constant; and
the charging current applied in the third charging phase is lower than the charging current applied in the second charging phase.

9. A method, comprising:
providing a charging voltage to a portable device, the charging voltage limited to a predetermined voltage at a predetermined current; and
in the portable device:
applying the charging voltage to charge a battery of the portable device in a charging phase; and
in the charging phase, causing the charging voltage to track a voltage of the battery while providing a constant current to the battery.

10. The method of claim 9, further comprising, in the charging phase, maintaining an offset of no more than about 200 millivolts between the voltage of the battery and the charging voltage.

11. The method of claim 9, further comprising:
in the portable device, fully turning on a first transistor and a second transistor in the charging phase;
wherein:
the first transistor couples a charging terminal to a load terminal; and
the second transistor couples the load terminal to the battery.

12. The method of claim 9, wherein:
the charging phase is a first charging phase;
the method includes:
in the portable device,
transitioning from the first charging phase to a second charging phase responsive to the voltage of the battery exceeding a first threshold; and
the charging voltage is constant in the second charging phase.

13. The method of claim 9, further comprising exiting the charging phase responsive to detection of an overvoltage fault or an overcurrent fault by the portable device.

14. The method of claim 9, wherein:
the charging phase is a first charging phase;
the method further comprises:
activating the first charging phase responsive to the voltage of the battery exceeding a threshold while charging the battery in a second charging phase;
in the second charging phase, the charging voltage is constant and the charging current is constant; and
the charging current applied in the second charging phase is lower than the charging current applied in the first charging phase.

15. The method of claim 14, wherein:
the threshold is a first threshold;
the method further comprises:
activating the second charging phase responsive to the voltage of the battery exceeding a second threshold while charging the battery in a third charging phase;
in the third charging phase, the charging voltage is constant and the charging current is constant; and
the charging current applied in the third charging phase is lower than the charging current applied in the second charging phase.

16. A battery charger circuit, comprising:
a linear charging control circuit coupled between an input terminal and a battery terminal, and configured to:
apply a charging voltage from the input terminal to the battery terminal; and
in a fast charging phase, cause the charging voltage to track a battery voltage while drawing a constant charging current.

17. The battery charger circuit of claim 16, wherein the linear charging control circuit is configured to, in the fast charging phase, maintain an offset of no more than about 200 millivolts between the battery voltage and the charging voltage.

18. The battery charger circuit of claim 16, further comprising:
a load terminal;
a first transistor coupled between the load terminal and the input terminal; and
a second transistor coupled between the load terminal and the battery terminal; and
wherein the linear charging control circuit is configured to, in the fast charging phase, fully turn on the first transistor and the second transistor.

19. The battery charger circuit of claim 16, wherein:
the linear charging control circuit is configured to transition from the fast charging phase to a second charging phase responsive to the battery voltage exceeding a first threshold; and
the charging voltage is constant in the second charging phase.

20. The battery charger circuit of claim 19, wherein the linear charging control circuit is configured to autonomously transition between the fast charging phase, the second charging phase, and a third charging phase.

21. The battery charger circuit of claim 20, wherein:
the linear charging circuit includes:
a temperature monitor circuit;
an overvoltage monitor circuit; and
an overcurrent monitor circuit, and
the linear charging circuit is configured to autonomously apply the charging voltage from the input terminal to the battery terminal; and protect a load circuit from voltage transients, current transients, and temperature transients.

22. The battery charger circuit of claim 16, wherein:
the linear charging control circuit is configured to:
activate the fast charging phase responsive to the battery voltage exceeding a threshold while applying the charging voltage from the input terminal to the battery terminal in a second charging phase;
in the second charging phase, the charging voltage is constant and the charging current is constant; and
the charging current applied in the second charging phase is lower than the charging current applied in the fast charging phase.

23. The battery charger circuit of claim 16, wherein the charging voltage is as low as 3.2 volts and the constant charging current is as high a one ampere.
